(19) United States
(12) Patent Application Publication
(10) Pub. No.: US 2006/0259953 A1
(43) Pub. Date: Nov. 16, 2006

(54) Method and apparatus for managing computer system access

(75) Inventors: John T. Earl, Gig Harbor, WA (US); Ronald Gary Monier, Kirkland, WA (US)

Correspondence Address: PowerTech Group Inc, 19426 68th Ave. South, Kent, WA, 98032, US

(73) Assignee: PowerTech Group Inc

(21) Appl. No.: 11/129,825

(22) Filed: May 16, 2005

(51) Int. Cl. H04L 9/32

(52) U.S. Cl. 726/2

(57) ABSTRACT

A method and apparatus for managing access to information in a computer system. A first profile is provided to one or more system users. The first profile indicates predetermined access privileges to the information in the computer system. The first profile may then be accessed by one of the system users. A system operator may enable system users to temporary access a second profile that indicates access privileges to additional information in the computer system. The system user may be enabled to temporarily swap the first profile with the second profile to provide a control in limiting the system user's access to information in the computer system.

### FIELD OF THE INVENTION

The invention relates to the field of managing access to information stored in a computer system.

### BACKGROUND

A method and apparatus for managing access to information stored in a computer system is disclosed.

Accessing computers to repair or update information (for example, files, records, programs or database content), such as those computers used by financial institutions, typically involves an authorized computer user or administrator logging into the computer system under a specific predefined profile. When the computer system is initially set-up, the specific profile is pre-assigned to the user. The profile defines the access rights to the information in the computer system. Once the user logs in to the computer system under a profile, the user can then access all information authorized for that profile including the information necessary for the user to perform a repair or upgrade.

One of the drawbacks of enabling the user access pursuant to the predefined profile is that the administrator may be able to access additional information in the computer system. Such access to additional information may be unnecessary to perform a repair or upgrade. Thus the administrator may obtain unauthorized access to additional highly sensitive information. Further the administrator may be able to unknowingly modify the files, programs or content thereby creating a system security breach. Finally once the profile is assigned, there may not be limitations on the time period the administrator can access the content or there may not be the ability for the administrator's access to be disabled without resetting the system.

### SUMMARY OF THE INVENTION

A method and apparatus for managing access to information in a computer system is disclosed. A first profile is provided to one or more system users. The first profile indicates predetermined access privileges to the information in the computer system. One of the system users may access the information in the computer system in accordance with the first profile. A system administrator may enable a system user to temporary use a second profile that indicates access privileges to additional information in the computer system. Such additional information may not be accessible in the first profile. The system user may provide an indication that they are changing their privileges to the help desk operator or any user, and temporarily swap their privileges enabled under the first profile with privileges under the second profile.

### DESCRIPTION OF THE FIGURES

FIG. 1 is a flow diagram of a computer system in accordance with the invention.

FIG. 2 is a flow diagram of the program running on a computer system in accordance with the invention.

FIG. 3a-3n are screen shots of the method for managing access to information in accordance with the invention.

FIG. 4 is a simplified block diagram of a computer system for managing access to information in accordance with the invention.

### DESCRIPTION OF THE PREFERRED EMBODIMENTS

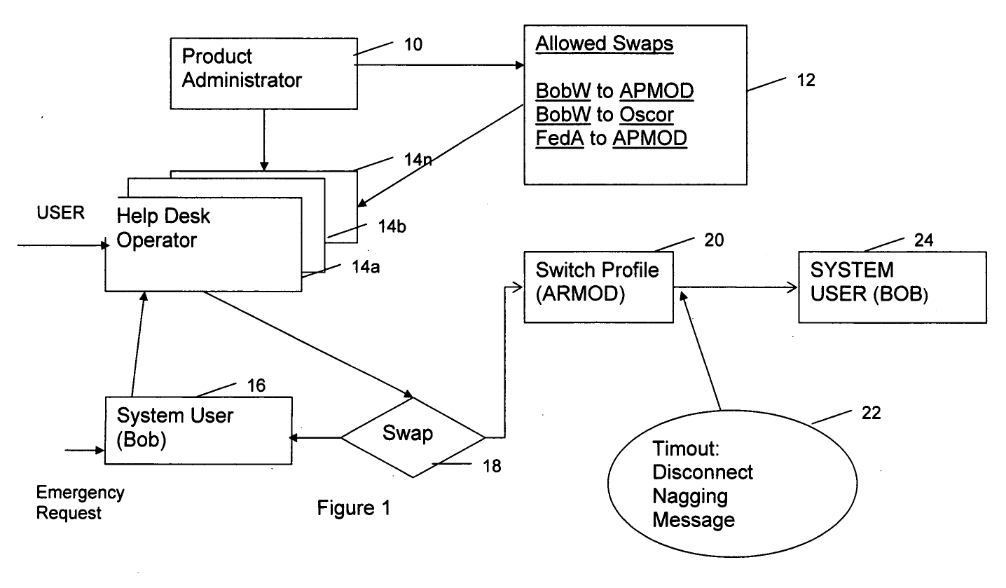

Referring to FIG. 1, there is shown a flow diagram of a software application being executed with a computer system (or multiplicity of systems) accessing information in accordance with the claimed embodiment. The application may be executed on any computer operating system, examples of which include, but are not limited to, Linux, Unix, Windows, as well as OS/400, i5/OS and associated iSeries, and AS400 computer systems that run such an operating system. The iSereis and AS400 computer systems and associated operating systems are available from IBM of Schenectady, N.Y.

When operating the system, a product or system administrator 10 may use the application to enable available profiles for a system user. Both the available profiles for a system user and record access rights associated with each of the profiles may preferably be pre-configured outside of the application, for example as part of the operating system set up, or upon initial installation of the application.

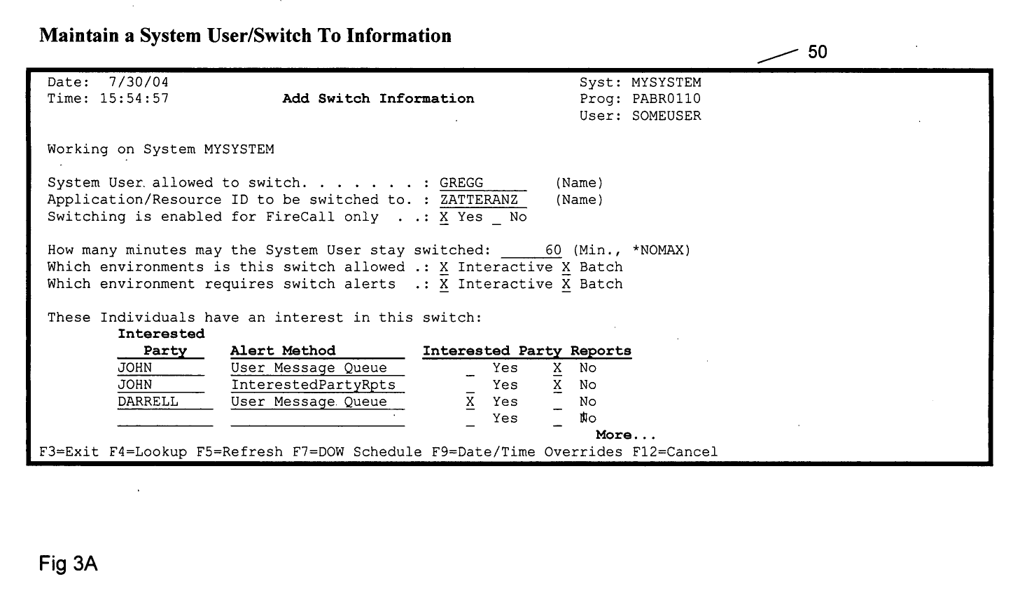

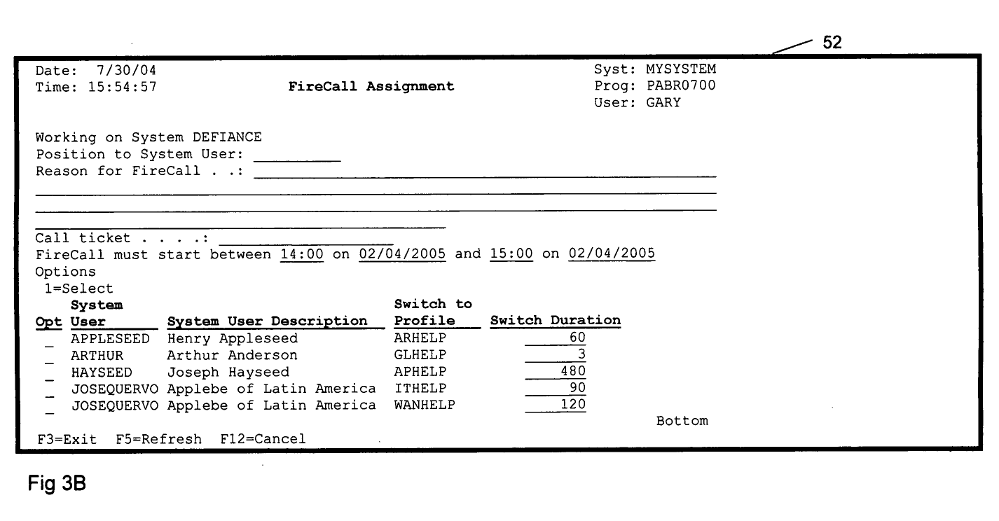

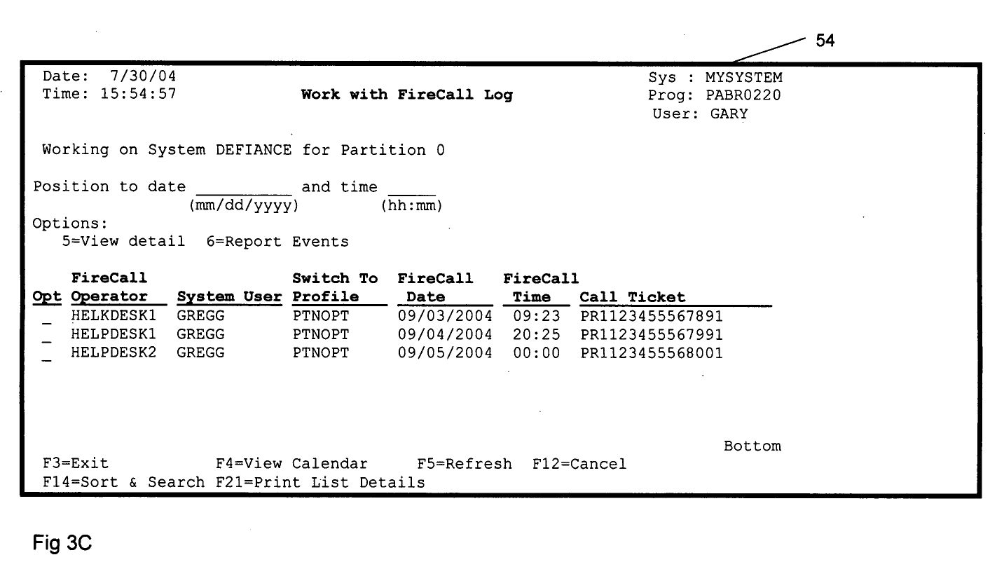

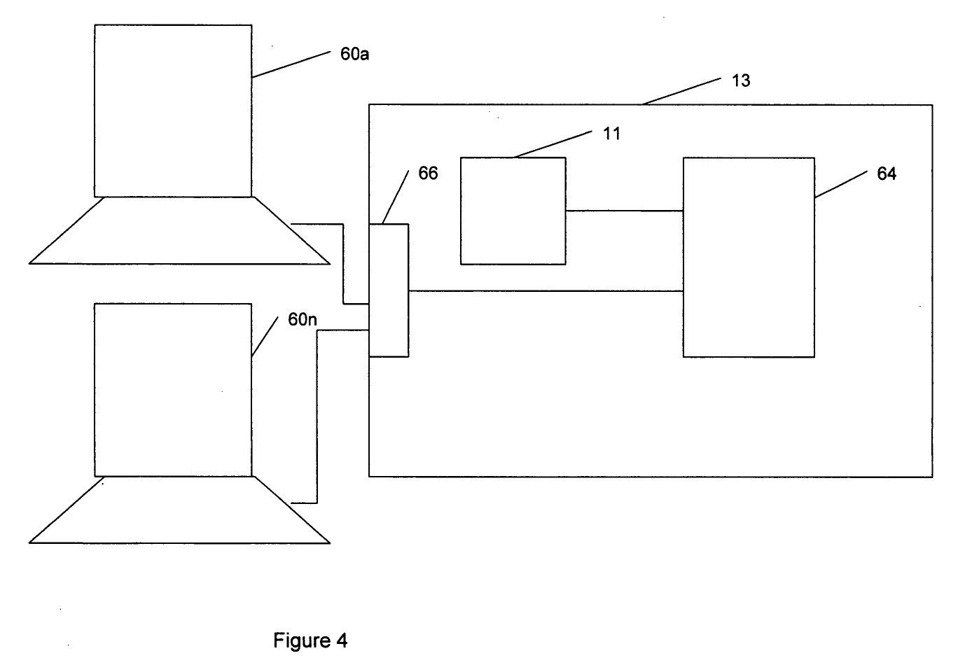

These profiles and rights associated with these profiles are stored in a database within a memory 11 of computer system 13 (FIG. 4). Memory 11 may be any type of information storage device, including but not limited to disk storage, hard drive, optical storage medium, Random Access Memory or silicon based memory. An exemplary graphical display showing a screen shot used in setting up these profiles is shown in FIG. 3A. System administrator configures a swap table 12, in memory 11, that defines available profiles that one or more help desk operators (also referred to herein as a system operator) 14a-14n can change for system users 16. The system administrator could also configure the times, dates and duration that system operator can change or enable change of a profile.

For example help desk operators 14a-n would be able to configure the application to enable the profile for system user BobW to be changed to another profile (e.g. APMOD or OSCOR), and would be able to configure the application to enable the profile for system user FEDA to be changed to another profile (e.g. APMOD).

During operation help desk operator 14a and a system user 16 (for example BobW) log into the system 13. Although help desk operator 14a and system user 16 are shown logging into the same system 13, help desk operator 14a could log into a computer different from and networked to the computer logged into by system user 16. When the operator 14 and system user 16 log into the system 13 they may login by providing generally known information such as a user id and a password. The help desk operator 14a may pre-configure a switch profile, i.e. the profiles in which that a system user 16 can change. For example, the help desk operator 14a may enable a user 16 to automatically, without any further intervention, to change the user's current profile (BOBW) to the profile of another user or of a pre-stored profile (APMOD). The help desk operator 14a may also disable the profile(s) in which system user 16 can change. The system user 16 may change its profile from BOBW to APMOD, for example upon login or as system user 16 determines such a change is necessary. The act of changing may herein be referred to as a profile switch or swap. Swapping, as used herein, may be understood to be the temporary assumption of another user's access rights and privileges. Such a change or swap may typically be done by a system user 16 in response to an emergency condition in the computer system 13 when the system user 16 needs access to information not normally associated with the system users' profile. This change or swap may herein also be referred to as a firecall operation.

The application in step 18 may then determines if the profile change that may have been requested by system user 16 is an available profile in swap table 12. If the profile change is available, help desk operator 14a may then enable the profile change in switch profile step 20 in accordance with allowed swap table 12 (e.g. change to APMOD). If the profile change requested by system user 16 is not in the swap table 12, then profile change would not be enabled and an indication could be sent to system user 16, upon a user attempting to change its profile to an unauthorized profile, indicating that the profile change was not authorized. If the profile change is not authorized, the user 16 may be prevented from changing its profile.

Once the profile change has been activated, the system user 16 could then be able to access information or records in the system in accordance with the rights provided under the switched profile (e.g. APMOD).

Various indications may be configured in step 22 by help desk operators 14a-n, once the switch profile has occurred. For example the help desk operator 14 a-n could configure the switch profile to be performed for a predetermined time period after which, the user's profile would timeout and revert to the system users original profile. An alert could be provided to the system user 16 indicating the time left until the profile reverts. After the timeout or after the system user 16 finishes its activity while user 16 has a specific profile, the profile for system user 16 could automatically revert from the changed profile (e.g. APMOD) to the system user's 16 original profile (e.g. BOBW) in step 24.

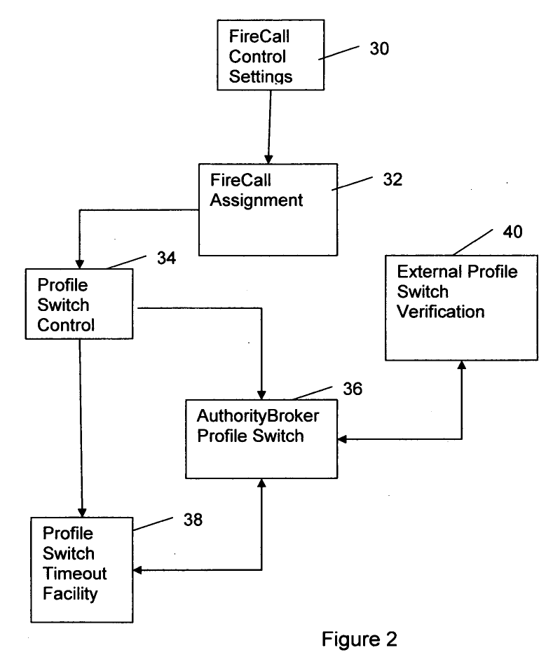

Referring to FIG. 2, there is shown a flow chart of an application that may be executed on an operating system (e.g. OS/400) that when run results in the firecall process described in FIG. 1.

In firecall control setting step 30, the firecall control settings are established. Establishing these setting may involve configuring initial control settings, updating a database in the computer system with the correct settings and setting up error handling settings in the event an operator attempts to type illegal or not allowed commands or configurations.

In firecall assignment step 32, the firecall assignment is set. More specifically parameters of the swap are selected including when the switch/swap can occur and the parameters of the user that must be preset to allow the switch.

In profile switch step 34, the parameters of which system users can switch to which profiles are set along with the quality of the switch pair. Also set are the parameters around the switch activity and the internal notifications for when the switch occurs. For example alarms could be automatically sent to various system users upon a switch, as well as upon a switch an automatic log entry of the switch could be stored in the systems memory.

After switch step 34, a profile switch timeout facility function could be established in step 38 where time periods are enabled for when users 16 could do a swap function. Also a disconnect log could be established during the time period.

Alternatively in profile switch step 36, a function could be built into the application to force the system user 16 to provide an explanation of why a switch is needed before such a user could activate the switch. In external profile switch verification step 40, a trigger could be automatically activated in the event of a switch. Such a trigger could generate an alarm or a message indication to a system user or any third party via a network.

Referring to FIG. 3A, there is shown an exemplary display screen of the initial setup of the swap table 50 which is stored in memory 11. The table may be completed by a product administrator and may specify the system user 16 that is allowed to switch, the application profile the user may switch to and the circumstances of the switch (e.g. a firecall). Other parameters that may be entered into table 50 are the time that the switch may be activated and individuals that are to be notified when the switch is activated.

Referring to FIG. 3b, there is shown an exemplary display screen 52 that may be completed by a help desk operator 14a, and stored in system memory 11 to effect the change in the switch profile. The help desk operator 14a may enter the reason for the switch, a call ticket number, the times of a firecall, duration of a swap table and enable the system users to activate the profile change or swap.

Referring to FIG. 3C, there is shown a log that may be provided as part of a profile change or swap. This log could be stored in memory 11 by the help desk operator 14a, or could automatically occur when the system user 16 initiates a swap.

Referring to FIG. 4, there is shown a computer system 13 coupled to terminals 60a-n that may execute the application described in FIGS. 1 and 2. Computer system 13, are generally known in to one skilled in the art and may include a processor 64 (or multiple processors) coupled to memory 11, examples of which may include but is not limited to, a storage media such as a RAM, optical drive, magnetic disk drive. The computer application described in FIG. 1 and FIG. 2 may be stored in memory 11. Processor 64 may be coupled to computer terminals 60a-60n through network interface 66. Processor 64 is generally known and may include a microprocessor or a central processing unit (CPU). Processor 64 executes the instruction stored in memory 11 and accesses data, information or records stored in memory 11. Although data is described stored in a memory 11 of computer system 13, data may be stored at remote locations on network 65. Terminals 60a-60n may be a dedicated standalone device or be a terminal emulator running on a pc, laptop, handheld device, mobile device or any computing device. Terminals 60a-60n may be disposed locally or at remote locations and be connected though network 65 via an internet or an intranet communications network.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method for managing access to information in a computer system comprising:
providing a first profile access to one or more system users, the first profile indicating predetermined access privileges to the information in the computer system;
accessing the first profile by one of the system users;
enabling, by a system operator, system users to temporary access a second profile, the second profile indicating access privileges to additional information in the computer system; and
temporarily swapping by a system user, the first profile with the second profile enabled by the system operator.

2. The method as recited in claim 1 further comprising providing a log of activity by the system user after temporarily swapping the first profile with the second profile.

3. The method as recited in claim 1 further comprising enabling, by the system operator, the system user to temporarily enable swapping the first profile with the second profile for a predetermined amount of time.

4. The method as recited in claim 3 where the predetermined amount of time remaining in the swap is indicated to the system user.

5. The method as recited in claim 1 wherein information in the second profile is not accessible in the first profile.

6. The method as recited in claim 1 further comprising enabling, by a system operator, system users to temporary access a third profile, the third profile indicating access privileges to additional information in the computer system; and temporarily swapping by a system user, the first profile with the third profile only when enabled by the system operator.

7. The method as recited in claim 1 further comprising: selectively disabling access by the system user to the second profile by the system operator, providing a indication requesting a temporarily swap the first profile with the second profile by the system user, and only enabling the temporary swap of the first profile with the second profile when such profile is enabled by the system operator.

8. A computer system comprising:
memory comprising a database of information having records;
display indicating a first profile that corresponds to predetermined access privileges by a system user to portions of the records in the memory and indicating a second profile that corresponds to predetermined access privilege by a system user to other portions of the records in the memory;
input device generating a signal indicating a first profile or a second profile;
processing circuit for enabling access to the memory in accordance with the first profile, said processing circuit enabling in response to the signal from the input device temporary access to the records in accordance with the second profile and disabling access to the records in accordance with the first profile when such access to the second profile has been enabled by a system operator.

9. The computer system as recited in claim 8 wherein the processing circuit is adapted to provide a log of activity by a system user after enabling temporarily access to the records in accordance with the second profile.

10. The computer system as recited in claim 8 where in the processing circuit is operative to enable the system user to temporarily access the records in accordance with the first profile for a predetermined amount of time.

11. The computer system as recited in claim 10 where the processing circuit specifies the predetermined amount of time is in accordance with signals received from the system operator.

12. The computer system as recited in claim 10 wherein the processing circuit is operative to disable the system user's access to the records in accordance with the second profile and enables the system user's access to the information in accordance with the first profile after a predetermined amount of time.

13. A computer readable medium having instructions which when executed by a processing device comprise:
storing in a memory a first profile to one or more system users, the first profile indicating predetermined access privileges to the information in the computer system;
accessing the first profile by one of the system users;
enabling, by a system operator, system users to temporary access a second profile, the second profile indicating access privileges to additional information in the computer system; and
temporarily swapping by one or more system users, the first profile with the second profile enabled by the system operator.

14. The computer readable media as recited in claim 13 further comprising instructions for providing a log of activity by the system user after temporarily swapping the first profile with the second profile.

15. The computer readable media as recited in claim 13 further comprising instructions for enabling the system user to temporarily swapping the first profile with the second profile for a predetermined amount of time.

16. The computer readable media as recited in claim 15 further comprising instructions enabling the predetermined amount of time to be specified by the system operator.

17. The computer readable media as recited in claim 13 wherein the information the system user is allowed access to in the second profile is not accessible in the first profile.

18. The computer readable media as recited in claim 13 further comprising instructions for disabling the system users access to the second profile; and preventing swapping by a system user, the first profile with the second profile, when access to the second profile is disabled by the system operator.

19. The computer readable media as recited in claim 13 further comprising instructions for preventing access by the system user to the second profile when such access is not enabled by the system operator.
